(19) United States
(12) Patent Application Publication
(10) Pub. No.: US 2004/0021883 A1
(43) Pub. Date: Feb. 5, 2004

(54) Method of and apparatus for generating proof image

(75) Inventor: Makoto Sugizaki, Minamiashigara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/610,597

(22) Filed: Jul. 2, 2003

(30) Foreign Application Priority Data
Jul. 5, 2002 (JP) NO. 2002-197656

(51) Int. Cl. H04N 1/52; H04N 1/405; H04N 1/58; H04N 1/409

(52) U.S. Cl. 358/1.9; 358/535; 358/536; 358/504; 358/533; 358/3.26; 358/3.2

(57) ABSTRACT

When a halftone dot image structure reproduction mode is selected in a proof image data generating apparatus, color image data are generated using threshold matrixes having respective screen angles which are essentially equal to the screen angles of printing plates for a color print and screen ruling ratios between the threshold matrixes which are essentially equal to the screen ruling ratios between the printing plates for the color print, and the processed color image data are supplied to a color printer. The color printer outputs a color proof having a rosette pattern similar to the rosette pattern in the color print based on the supplied color image data.

### BACKGROUND OF THE INVENTION

1. Field of the Invention

The present invention relates to a method of and an apparatus for generating a proof image of a printed halftone dot image which is generated by superposing a plurality of halftone dot images.

2. Description of the Related Art:

In the art of printing, it has been customary to generate a color print having desired colors and gradations by generating printing plates for respective colors, i.e., C, M, Y, K with a printing plate generating apparatus such as an image setter, a CTP (Computer To Plate) apparatus, or a CTC (Computer To Cylinder) apparatus, and thereafter superposing halftone dot images on a printing press using the generated printing plates.

Since a number of processing steps are required to generate a color print, it is desirable to output proof images in advance for the operator to confirm image colors and halftone dot image structures. Heretofore, a proof image generating apparatus having an output resolution that is substantially the same as a printing plate generating apparatus in order to generate proof images for a color print has been used. However, such a proof image generating apparatus is rather expensive and imposes a considerable burden if only a small number of prints are to be generated.

In recent years, it has been attempted to generate proof images on a relatively inexpensive image generating apparatus, typically an ink jet printer. Generally, the ink jet printer converts a continuous-gradation image data into binary image data according to an error diffusion process and generates a proof image based on the binary image data. Though the color proofing of a color print can be made based on the proof image thus generated, the image is unable to provide an accurate reproduction of a halftone dot image structure which is indicative of the texture of the color print.

Specifically, a color print comprises superposed halftone dot images that are generated from the respective printing plates in C, M, Y, K. In order to minimize the appearance of a moire, the printing plates in C, M, K are generated such that they have respective screen angles that are shifted 30° from each other. Since the effect of a moire on the printing plate in Y is less visible, the printing plate in Y has its screen angle set to a value intermediate between the screen angles of any desired printing plates. When a color print is generated from the printing angles whose screen angles have thus been set, the color print has a halftone dot image structure referred to as a rosette pattern due to the superposition of the three printing plates in C, M, K. Therefore, it is desirable for a proof image to reproduce a rosette pattern as accurately as possible.

The printing plate generating apparatus and the image generating apparatus such as an ink jet printer or the like have different output resolutions. Consequently, even if the same screen angles are established in the printing plate generating apparatus, it is impossible to establish the same screen rulings in the printing plate generating apparatus. Therefore, a rosette pattern that appears in a proof image has a different shape from a rosette pattern that appears in a color print, making it difficult to inspect a halftone dot image structure in the color print.

### SUMMARY OF THE INVENTION

It is a general object of the present invention to provide a method of and an apparatus for generating, easily at a low cost, a proof image having a halftone dot image structure which is very close to that of a printed image, using a proof image generating apparatus which has an output resolution different from that of a printed image generating apparatus.

A principal object of the present invention is to provide a method of and an apparatus for generating a color proof having a halftone dot image structure which is very close to that of a printed color image.

Another object of the present invention is to provide a method of and an apparatus for selecting and generating a desired proof image which depends on a color or a halftone dot image structure in a printed halftone dot image.

A halftone dot image structure appearing in a proof image depends on the screen angles of respective halftone dot images to be superposed and also screen ruling ratios between the halftone dot images. In a proof image generating apparatus, threshold matrixes are set whose screen angles and screen ruling ratios are essentially equal to those in a printed image generating apparatus. Using the threshold matrixes thus set, the proof image generating apparatus which has an output resolution different from the output resolution of the printed image generating apparatus can generate a proof image having a halftone dot image structure, e.g., a rosette pattern, equivalent to that in a printed image.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a printing system according to an embodiment of the present invention;

FIG. 2 is a block diagram of a proof image data generating apparatus in the printing system shown in FIG. 1;

FIG. 3 is a block diagram of a halftone dot image structure regenerator in the proof image data generating apparatus shown in FIG. 2;

FIG. 4 is a diagram showing a supercell whose screen angle is set to θ and dot cells that make up the supercell;

FIG. 5 is a diagram showing a rosette pattern in a color print;

FIG. 6 is a flowchart of a proof image generating method according to embodiment of the present invention;

FIG. 7 is a table showing the relationship between screen angles, screen rulings, and screen ruling ratios of plates for generating a color print;

FIG. 8 is a table showing the relationship between screen angles, screen rulings, and screen ruling ratios of plates for generating a color proof; and

FIG. 9 is a diagram showing a rosette pattern in a color proof.

### DESCRIPTION THE PREFERRED EMBODIMENT

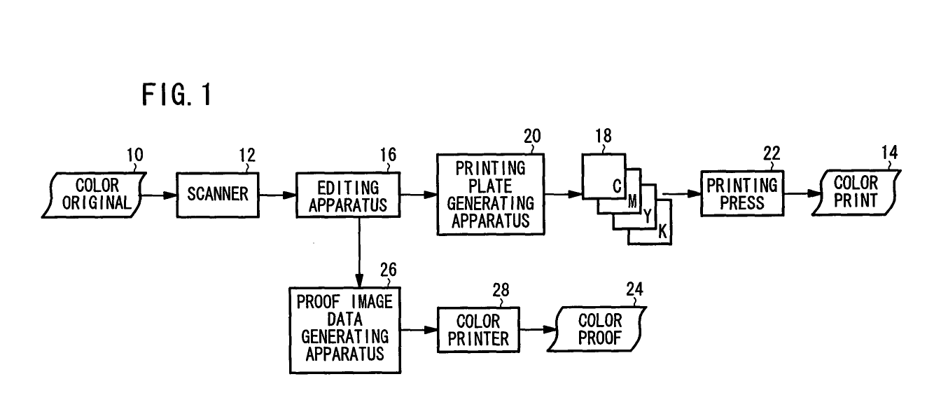

FIG. 1 shows in block form a printing system to which a method of and an apparatus for generating a proof image according to the present invention are applied.

As shown in FIG. 1, the printing system comprises a scanner 12 for reading a color original 10 including a continuous-gradation image, an editing apparatus 16 for performing an editing process including an image processing process on color image data supplied from the scanner 12 in order to obtain a desired color print 14, a printing plate generating apparatus 20 for outputting four printing plates 18 in C, M, Y, K based on color image data which have been edited by the editing apparatus 16, and a printing press 22 for generating a color print 14 comprising a halftone dot image based on the printing plates 18.

The editing apparatus 16 is connected to a proof image data generating apparatus 26 for generating a color proof 24 which regenerates colors or a halftone dot image structure of a color print 14. The proof image data generating apparatus 26 performs a predetermined image processing process on color image data supplied from the editing apparatus 16 to generate proof image data. The proof image data generating apparatus 26 is connected to a color printer 28 such as an ink jet printer or the like which has an output resolution lower than the printing plate generating apparatus 20. The color printer 28 outputs a color proof 24 based on proof image data generated by the proof image data generating apparatus 26. The proof image data generating apparatus 26 and the color printer 28 jointly make up a proof image generating apparatus.

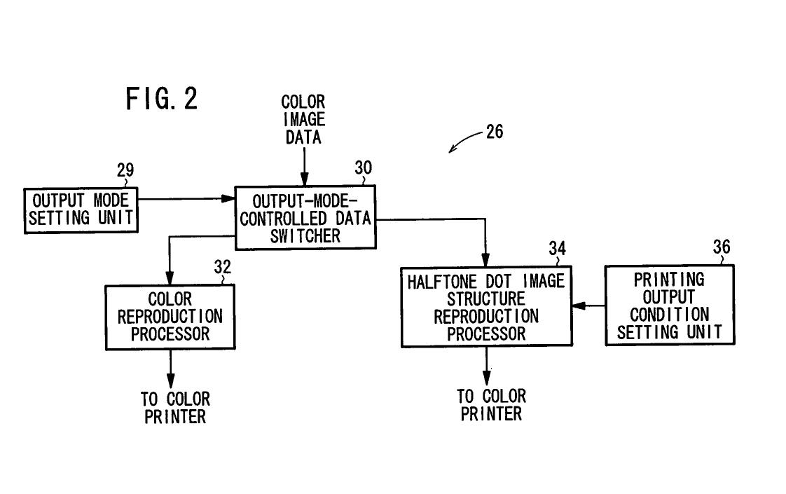

FIG. 2 shows the proof image data generating apparatus 26 in block form. As shown in FIG. 2, the proof image data generating apparatus 26 has an output mode setting unit 29 for setting either one of a color reproduction mode for reproducing the colors of the color print 14 and a halftone. dot image structure reproduction mode for reproducing the halftone dot image structure of the color print 14 which comprises a halftone dot image, and an output-mode-controlled data switcher 30 for switching color image data depending on the output mode that has been set by the output mode setting unit 29. The output-mode-controlled data switcher 30 is connected to a color reproduction processor 32 for effecting a color reproduction process on supplied color image data and a halftone dot image structure reproduction processor 34 for effecting a halftone dot image structure reproduction process on supplied color image data. The halftone dot image structure reproduction processor 34 is connected to a printing output condition setting unit 36 for setting printing output conditions set in the printing plate generating apparatus 20 in the proof image data generating apparatus 26. The halftone dot image structure reproduction processor 34 performs a halftone dot image structure reproduction process on supplied color image data based on printing output conditions set by the printing output condition setting unit 36, thereby generating proof image data.

The printing output conditions include the output resolution of the printing plate generating apparatus 20 which outputs the printing plates 18, the screen angles of respective threshold matrixes used to output the printing plates 18 in C, M, K, and the screen rulings of the respective of threshold matrixes. The output resolution, the screen angles, and the screen rulings may be of such values that, for example, a screen ruling which is of an accurate value of 173.763 (lpi) may be set as a nominal value of 175 (lpi), and the printing output condition setting unit 36 may convert the nominal value into an actual value and supply the actual value to the halftone dot image structure reproduction processor 34.

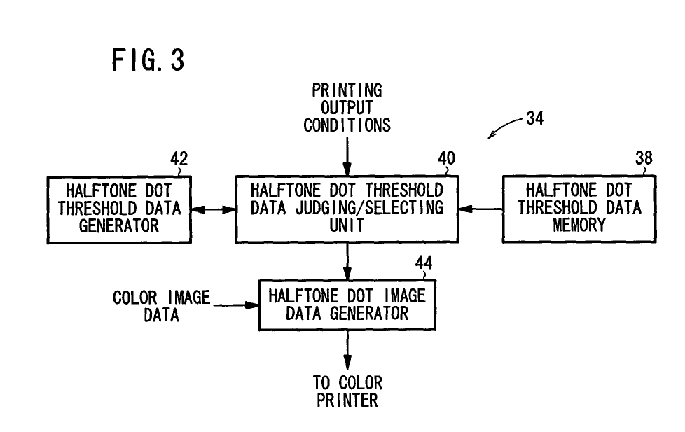

FIG. 3 shows in block form the halftone dot image structure reproduction processor 34 in the proof image data generating apparatus 26. As shown in FIG. 3, the halftone dot image structure reproduction processor 34 has a halftone dot threshold data memory 38 for storing halftone dot threshold data which make up a plurality of threshold matrixes corresponding to printing output conditions. The halftone dot threshold data memory 38 stores halftone dot threshold data and also screen angles and screen rulings thereof.

The halftone dot image structure reproduction processor 34 also has a halftone dot threshold data judging/selecting unit 40 for judging whether halftone dot threshold data capable of generating a desired halftone dot image structure corresponding to the printing output conditions set in the printing plate generating apparatus 20 are stored in the halftone dot threshold data memory 38 or not, and, if the halftone dot threshold data are stored in the halftone dot threshold data memory 38, selecting the stored halftone dot threshold data, a halftone dot threshold data generator 42 for generating desired halftone dot threshold data if the halftone dot threshold data are not stored in the halftone dot threshold data memory 38, and a halftone dot image data generator 44 for generating halftone dot image data as binary image data by comparing the magnitude of the halftone dot threshold data selected from the halftone dot threshold data memory 38 or the halftone dot threshold data generated by halftone dot threshold data generator 42 with the color image data.

The printing system according to the present invention is basically constructed as described above. Operation of the printing system will be described below.

Color image data produced by reading the color original 10 by the scanner 12 are sent to the editing apparatus 16, which performs an image processing process including color correction, etc. in order to obtain a desired color print 14. Thereafter, the processed color image data are supplied as color image data in different colors, i.e., C, M, Y. X, to the printing plate generating apparatus 20. In the printing plate generating apparatus 20, the processed color image data in the respective colors are converted into halftone dot image data in the respective colors using threshold matrixes which comprise desired screen angles and screen rulings, and printing plates 18 in C, M, Y, K are generated from the respective halftone dot image data. The generated printing plates 18 are supplied to the printing press 22, which transfer inks in C, M, Y, K overlappingly to a given print sheet using the printing plates 18, thus producing a color print 14.

In the printing plate generating apparatus 20, the screen angles of the threshold matrixes for the color image data in C, M, Y, K are set to angles that are capable of minimizing the visual perception of a moire which tends to appear when the halftone dot images in C, M, Y, K are superposed. At this time, since a moire due to the halftone dot image in Y is less visible, it is the usual practice to maximize the screen angles for the three colors of C, M, K and set the screen angle for the color of Y to a value between the screen angles for C, M, K. For example, the screen angles of the printing plates in C, M, Y, K are set so as to be as close as possible to 15°, 45°, 0°, 75°, respectively.

The screen rulings of the threshold matrixes are selected and set depending on the type of the color print 14 to be output, based on the output resolution and screen angles of the printing plate generating apparatus 20.

The screen angles and screen rulings of the threshold matrixes in the printing plate generating apparatus 20 are determined as follows:

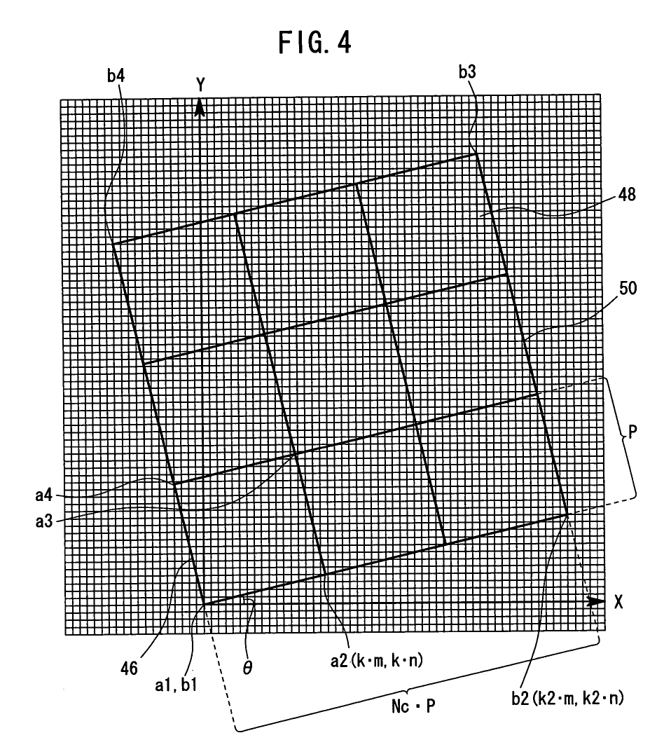

FIG. 4 shows the relationship between a dot cell 46 (a range surrounded by grip points a1-a4) having a screen angle θ which comprises a plurality of threshold halftone dot data making up a threshold matrix, and pixels 48 that are generated in a main scanning direction (indicated by the arrow X) and an auxiliary scanning direction (indicated by the arrow Y) of the printing plate 18 by a laser beam or the like.

In order to digitally generate the halftone dot threshold data that make up the dot cell 46, it is necessary to set the screen angle θ to meet a certain condition of rational tangent. Specifically, in order to associate the halftone dot threshold data with the pixels 48, the grid points a1-a4 of the dot cell 46 need to be placed on the grid of the pixels 48. Using integers m, n which are mutually prime, the following relationship:

θ=tan⁻¹(n/m) (1)

represents the condition of rational tangent. If the dot cell 46 having pixels 48 as its units has a pitch P, then the pitch P is expressed as follows:

P=k·√(m²+n²) (2)

where k represents an integer which is not 0. The equation (2) expresses the condition in which the dot cell 46 becomes rational tangent, with the parameters m, n relative to the screen angle θ and the pitch P of the dot cell 46.

In order to bring the screen angle θ closely to an ideal angle, the pitch P needs to be set to a large value and the dot cell 46 needs to be made up of a number of halftone dot threshold data, and therefore the amount of data of the threshold matrix is considerably increased. To solve this problem, the concept of a supercell 50 (a range surrounded by grip points b1-b4) made up of a cluster of dot cells 46 is introduced. The grip points b1-b4 of the supercell 50 are positioned on the grid of pixels 48. If the number of dot cells 46 on one side of the supercell 50 is represented by Nc and the integer which is not 0 is represented by k2, then the relationship between the parameters m, n and the pitch P is expressed by:

P=k2·√(m²+n² )/Nc (3)

In this case, a threshold matrix having a screen angle θ which is close to an ideal angle is obtained without greatly increasing the amount of data.

The screen ruling L (lpi: lines per inch) of a threshold matrix refers to the number of dot cells per inch, and is expressed as the reciprocal of the pitch P of the dot cell 46 as follows:

L=1/P (4)

Therefore, if the output resolution of the printing plate generating apparatus 20 is represented by res (dpi: dots per inch), then the screen ruling L is set from the equations (3), (4) as follows:

L=res/(Nc/√(m²+n²)/k2) (5)

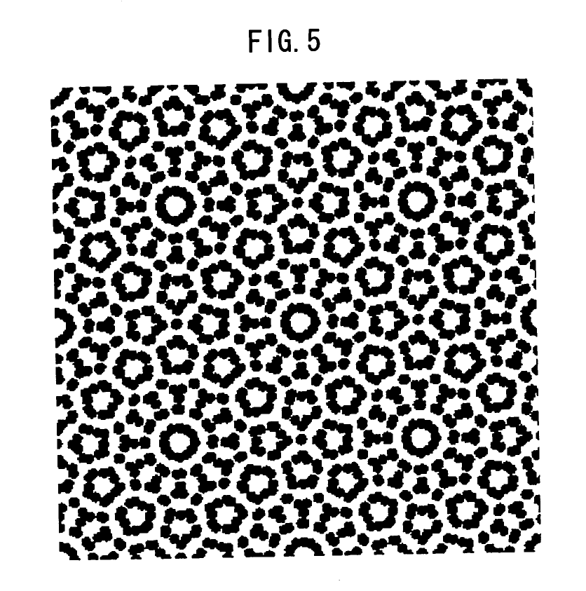

FIG. 5 shows an example of the color print 14 which is generated using printing plates 18 that have been generated by the printing plate generating apparatus 20 whose output resolution is res =2438.4(dpi), under the screen angle θ=15.256(°) for C, the screen angle θ=45(°) for M, and the screen angle θ=74.747(°) for K which are set according to the equation (1), and the screen ruling L=173.763 (lpi) for C, the screen ruling L=172.421 (lpi) for M, and the screen ruling L=173.763 (lpi) for K which are set according to the equation (5). Since the screen angle θ between the color images in C, M, K is about 30° in the color print 14, the color print 14 has a rosette pattern which is a halftone dot image structure.

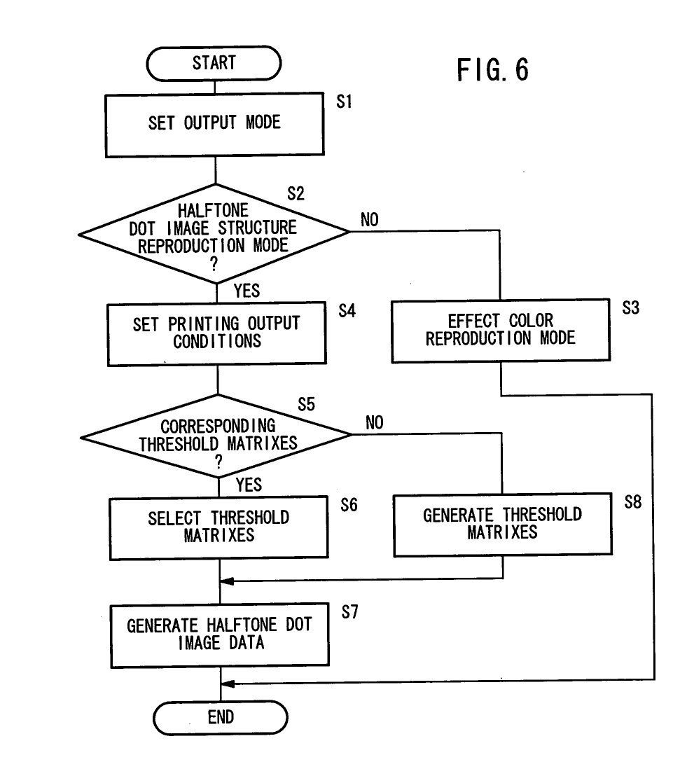

A method of generating the color proof 24 with the proof image data generating apparatus 26 and the color printer 28 which are capable of reproducing a halftone dot image structure such as a rosette pattern will be described below with reference to FIG. 6.

The color image data which have been edited by the editing apparatus 16 in order to obtain a desired color print 14 are supplied to the proof image data generating apparatus 26. In the proof image data generating apparatus 26, the output mode setting unit 29 sets an output mode according to the operator's instruction in step S1, thus determining whether the colors of a color print 14 are to be reproduced or the halftone dot image structure of a color print 14 is to be reproduced.

The proof image data generating apparatus 26 determines whether the color reproduction mode or the halftone dot image structure reproduction mode is set by the output mode setting unit 29 in step S2. If the color reproduction mode is set in step S, then the output-mode-controlled data switcher 30 (see FIG. 2) supplies the color data from the editing apparatus 16 to the color reproduction processor 32. The color reproduction processor 32 converts the color image data in C, M, Y, K into binary image data using an FM screen having a large color reproduction range or an error diffusion process in step S3.

The generated binary image data are supplied to the color printer 28, which outputs a color proof 24. The operator can predict the colors of a color print 14 in advance using the generated color proof 24.

If the halftone dot image structure reproduction mode is set in step S1, then the printing output condition setting unit 36 sets printing output conditions in step S4.

At this time, the output resolution of the printing plate generating apparatus 20, and the screen angles and screen rulings of threshold matrixes used to output printing plates 18 in C, M, K are set as the printing output conditions.

After the printing output conditions have been set, the halftone dot threshold data judging/selecting unit 40 (see FIG. 3) in the halftone dot image structure reproduction processor 34 judges whether halftone dot threshold data corresponding to the set printing output conditions are stored in the halftone dot threshold data memory 38 or not in step S5. Specifically, the halftone dot threshold data judging/selecting unit 40 judges whether the halftone dot threshold data which make up threshold matrixes whose screen angles are essentially equal to the screen angles of the threshold matrix s in C, M, K that have been set as the printing output conditions, and whose screen ruling ratios are essentially equal to the screen ruling ratios of the threshold matrixes in C, M, K that have been set as the printing output conditions are stored in the halftone dot threshold data memory 38 or not.

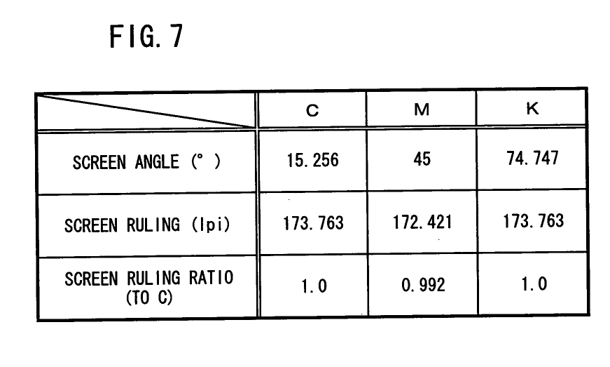

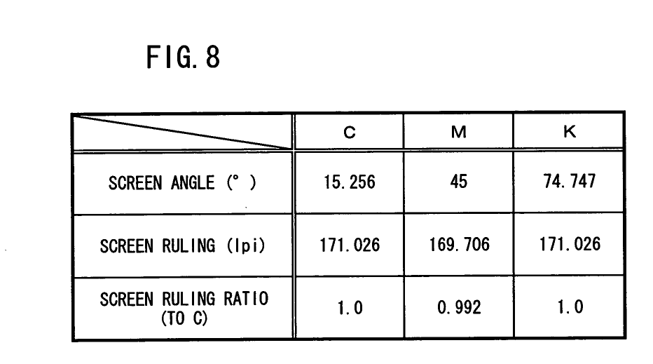

FIG. 7 shows the screen angles, screen rulings, and screen ruling ratios with respect to C of the threshold matrixes in C, M, K that are set in the printing plate generating apparatus 20 whose output resolution is 2438.4(dpi). FIG. 8 shows the screen angles, screen rulings, and screen ruling ratios with respect to C of the threshold matrixes in C, M, K that are set in the color printer 28 whose output resolution is 720 (dpi).

The screen angles can be set essentially equally in the printing plate generating apparatus 20 and the proof image data generating apparatus 26 so that an optimum rosette pattern will be generated. The screen rulings are difficult to be set essentially equally in the printing plate generating apparatus 20 and the proof image data generating apparatus 26 because of their different output resolutions in view of the equation (5). The screen ruling ratios can be set essentially equally between the colors of C, M, K.

If halftone dot threshold data corresponding to the set printing output conditions are stored in the halftone dot threshold data memory 38 in step S5, then the halftone dot threshold data judging/selecting unit 40 selects the halftone dot threshold data from the halftone dot threshold data memory 38 in step S6, and supplies the selected halftone dot threshold data to the halftone dot image data generator 44, which generates halftone dot image data in C, M, Y, K by comparing the halftone dot threshold with the color image data in step S7. The generated halftone dot image data are supplied to the color printer 28, which outputs a color proof 24 having a halftone dot image structure. The operator can predict the halftone dot image structure of a color print 14 in advance, using the color proof 24 output from the color printer 28.

In the halftone dot image structure reproduction mode, a color matching process may be carried out to compare the colors to a certain extent though not as effective as the color reproduction mode.

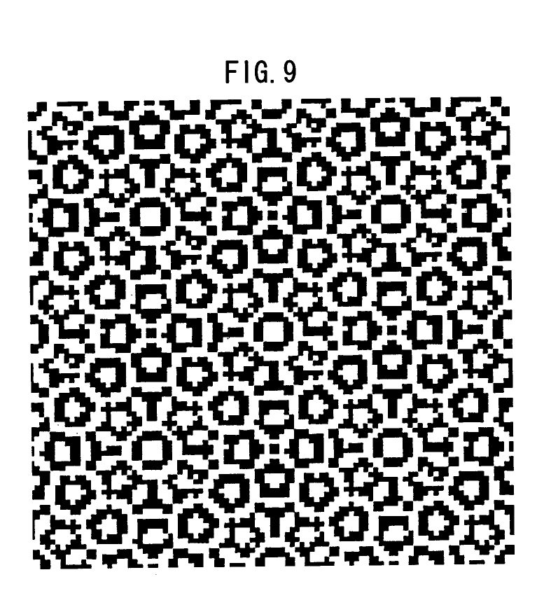

FIG. 9 shows an example of the color proof 24 which is generated by selecting the threshold matrixes based on the screen angles, the screen rulings, and the screen ruling ratios shown in FIG. 8, under the printing output conditions based on the screen angles, the screen rulings, and the screen ruling ratios shown in FIG. 7. Although the screen rulings for C, M, K shown FIGS. 7 and 8 are different from each other, since their relative ratios are essentially the same, the color proof 24 contains a rosette pattern which is the same halftone dot image structure as that in the color print 14 as shown in FIG. 5.

If the halftone dot threshold data memory 38 does not store halftone dot threshold data corresponding to the set printing output conditions in step S5, then the halftone dot threshold data generator 42 generates threshold matrixes having screen ruling ratios which are essentially the same as the screen ruling ratios in the printing plate generating apparatus 20 according to the equation (5) in step S8. The halftone dot image data generator 44 generates halftone dot image data in C, M, Y, K using the generated threshold matrixes in step S7. The color printer 28 then generates a color proof 24 having a halftone dot image structure, using the generated halftone dot image data.

In the above embodiment, a rosette pattern which is the same halftone dot image structure as that in the color print 14 is generated by essentially equalizing the screen ruling ratios between the printing plates in C, M, K. However, a halftone dot image structure may be generated by essentially equalizing the screen ruling ratios between any two desired printing plates.

The screen rulings for generating the color print 14 and the screen rulings for generating the color proof 24 should preferably be as close to each other as possible. Preferably, the difference between the screen rulings for generating the color print 14 and the screen rulings for generating the color proof 24 should be 3 or less.

Although a certain preferred embodiment of the present invention has been shown and described in detail, it should be understood that various changes and modifications may be made therein without departing from the scope of the appended claims.

What is claimed is:

1. A method of generating a proof image for a printed halftone dot image which is generated by superposing at least two halftone dot images which are generated by a printed halftone dot image generating apparatus using threshold matrixes having at least two different screen angles and desired screen rulings, with a proof image generating apparatus having an output resolution which is different from an output resolution of said printed halftone dot image generating apparatus, said method comprising the steps of:
setting a plurality of threshold matrixes having respective screen angles essentially equal to screen angles in said printed halftone dot image generating apparatus, and setting screen ruling ratios between the threshold matrixes, said screen ruling ratios being essentially equal to screen ruling ratios in said printed halftone dot image generating apparatus; and
generating said proof image with said proof image generating apparatus using the threshold matrixes.

2. A method according to claim 1, wherein three threshold matrixes whose screen ruling ratios between the threshold matrixes are essentially equal to screen ruling ratios between three threshold matrixes set in said printed halftone dot image generating apparatus are set, and a rosette pattern of said printed halftone dot image is reproduced by said proof image generating apparatus.

3. A method according to claim 2, wherein said three threshold matrixes generate proof images in colors of C, M, K.

4. A method according to claim 1, wherein each of said threshold matrixes comprises halftone dot threshold data of a plurality of dot cells which make up a supercell.

5. A method according to claim 1, wherein screen rulings of the threshold matrixes set in said printed halftone dot image generating apparatus and screen rulings of the threshold matrixes set in said proof image generating apparatus differ from each other by 3% at the most.

6. An apparatus for generating a proof image for a printed halftone dot image which is generated by superposing a plurality of halftone dot images in different printing colors, said apparatus comprising:
a color reproduction processor for reproducing colors of said printed halftone dot image;
a halftone dot image structure reproduction processor for reproducing a halftone dot image structure of said printed halftone dot image; and
a switcher for selectively switching to said color reproduction processor and said halftone dot image structure reproduction processor;
wherein said halftone dot image structure reproduction processor sets threshold matrixes having respective screen angles essentially equal to screen angles in a printed halftone dot image generating apparatus for generating said printed halftone dot image, and sets screen ruling ratios, between the threshold matrixes, essentially equal to screen ruling ratios in said printed halftone dot generating apparatus, and generates said proof image using the threshold matrixes.

7. An apparatus for generating a proof image for a printed halftone dot image, said apparatus having an output resolution different from an output resolution of a printed halftone dot image generating apparatus for generating the printed halftone dot image using a plurality of threshold matrixes, said apparatus comprising:
a threshold matrix memory for storing a plurality of threshold matrixes having different screen angles and screen rulings;
a threshold matrix selector for selecting, from said threshold matrix memory, a plurality of threshold matrixes having respective screen angles essentially equal to screen angles in said printed halftone dot image generating apparatus and screen ruling ratios between the threshold matrixes, said screen ruling ratios being essentially equal to screen ruling ratios in said printed halftone dot image generating apparatus; and
a proof image generator for generating the proof image using the selected threshold matrixes.

8. An apparatus according to claim 7, further comprising:
a judging unit for judging whether desired threshold matrixes can be selected from said threshold matrix memory or not; and
a threshold matrix generator for generating desired threshold matrixes if said judging unit decides that desired threshold matrixes cannot be selected from said threshold matrix memory.
